(19) United States
(12) Patent Application Publication
(10) Pub. No.: US 2015/0362989 A1
(43) Pub. Date: Dec. 17, 2015

(54) DYNAMIC TEMPLATE SELECTION FOR OBJECT DETECTION AND TRACKING

(71) Applicant: Amazon Technologies, Inc., Reno, NV (US)

(72) Inventors: Ambrish Tyagi, Palo Alto, CA (US); Kah Kuen Fu, Sunnyvale, CA (US); Tianyang Ma, San Jose, CA (US); Kenneth Mark Karakotsios, San Jose, CA (US); Michael Lee Sandige, Sammamish, WA (US); David Wayne Stafford, Cupertino, CA (US); Steven Bennett, Seattle, WA (US)

(21) Appl. No.: 14/307,483

(22) Filed: Jun. 17, 2014

(51) Int. Cl. G06F 3/01; G06K 9/62; G06K 9/20; H04N 5/33; H04N 7/18; G06K 9/00

(52) U.S. Cl. CPC G06F 3/011; G06F 3/017; H04N 7/18; G06K 9/00268; G06K 9/2027; G06K 9/209; H04N 5/33; G06K 9/6201; G06K 9/6256

(57) ABSTRACT

Object tracking, such as may involve face tracking, can utilize different detection templates that can be trained using different data. A computing device can determine state information, such as the orientation of the device, an active illumination, or an active camera to select an appropriate template for detecting an object, such as a face, in a captured image. Information about the object, such as the age range or gender of a person, can also be used, if available, to select an appropriate template. In some embodiments instances of templates can be used to process various orientations, while in other embodiments specific orientations, such as upside down orientations, may not be processed for reasons such as rate of inaccuracies or infrequency of use for the corresponding additional resource overhead.

### BACKGROUND

As the capabilities of portable computing devices continue to improve, and as users are utilizing these devices in an ever increasing number of ways, there is a corresponding need to adapt and improve the ways in which users interact with these devices. Certain devices use motions such as gestures or head tracking for input to various applications executing on these devices. While head tracking algorithms perform adequately under certain conditions, there are variations and conditions that can cause these algorithms to perform less accurately than desired, which can lead to false input and user frustration. Further, inaccuracies in face or head tracking can cause developers to shy away from incorporating such input into their applications and devices.

### BRIEF DESCRIPTION OF THE DRAWINGS

Various embodiments in accordance with the present disclosure will be described with reference to the drawings, in which:

FIGS. 1(a) and 1(b) illustrate an example environment in which a user can interact with a portable computing device in accordance with various embodiments;

FIGS. 2(a), 2(b), 2(c), 2(d), and 2(e) illustrates an example head tracking approach that can be utilized in accordance with various embodiments;

FIGS. 3(a), 3(b), 3(c), 3(d), 3(e), 3(f), 3(g), and 3(h) illustrate example images that can be used to attempt to determine a face or head location in accordance with various embodiments;

FIG. 4 illustrates an example process for dynamically selecting a template to use for face tracking that can be utilized in accordance with various embodiments;

FIG. 5 illustrates an example process for postponing or suspending a face location or tracking process that can be utilized in accordance with various embodiments;

FIG. 6 illustrates an example device that can be used to implement aspects of the various embodiments;

FIG. 7 illustrates example components of a client device such as that illustrated in FIG. 6; and

FIG. 8 illustrates an environment in which various embodiments can be implemented.

### DETAILED DESCRIPTION

Systems and methods in accordance with various embodiments of the present disclosure overcome one or more of the above-referenced and other deficiencies in conventional approaches to determining and/or tracking the relative position of an object, such as the head or face of a user, using an electronic device. In particular, various embodiments discussed herein provide for the dynamic selection of a tracking template for use in face, head, or user tracking based at least in part upon a state of a computing device, an aspect of the user, and/or an environmental condition. The template used can be updated as the state, aspect, and/or environmental condition changes. Further, in order to reduce the number of false positives as well as the amount of processing capacity needed, in some embodiments a computing device can suspend a tracking process when the device is in a certain orientation, such as upside down, or within a range of such orientations.

Various other functions and advantages are described and suggested below as may be provided in accordance with the various embodiments.

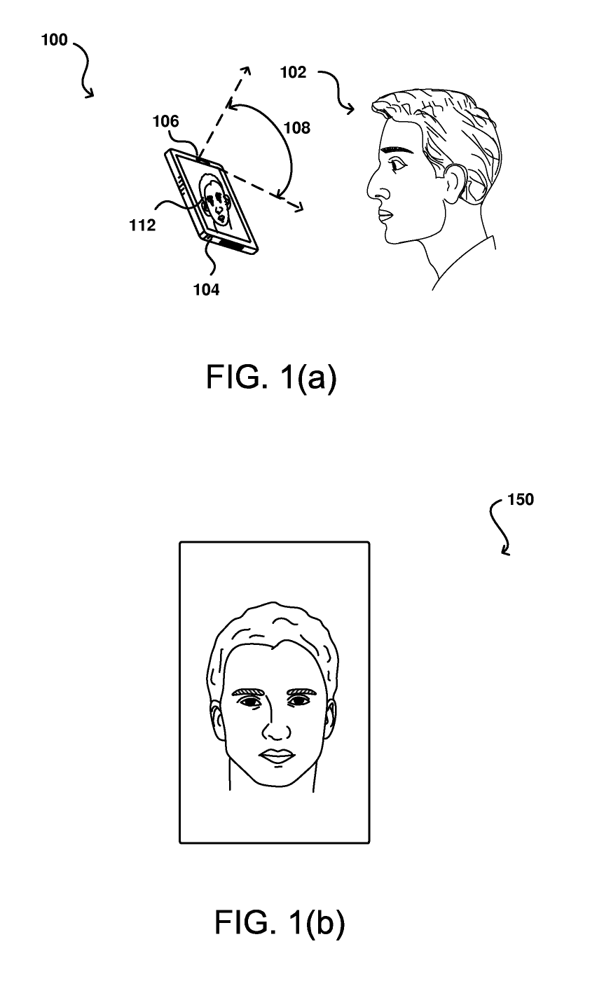

FIG. 1(a) illustrates an example environment 100 in which aspects of the various embodiments can be implemented. In this example, a user 102 is interacting with a computing device 104. During such interaction, the user 102 will typically position the computing device 104 such that at least a portion of the user (e.g., a face or body portion) is positioned within an angular capture range 108 of at least one camera 106, such as a primary front-facing camera, of the computing device. Although a portable computing device (e.g., an electronic book reader, smart phone, or tablet computer) is shown, it should be understood that any electronic device capable of receiving, determining, and/or processing input can be used in accordance with various embodiments discussed herein, where the devices can include, for example, desktop computers, notebook computers, personal data assistants, video gaming consoles, television set top boxes, smart televisions, wearable computers (e.g., smart watches, biometric readers and glasses), portable media players, and digital cameras, among others. In some embodiments the user will be positioned within the angular range of a rear-facing or other camera on the device, although in this example the user is positioned on the same side as a display element 112 such that the user can view content displayed by the device during the interaction. FIG. 1(b) illustrates an example of an image 150 that might be captured by the camera 106 in such a situation, which shows the face, head, and various features of the user.

The ability to determine the relative location of a user with respect to a computing device enables various approaches for interacting with such a device. For example, a device might render information on a display screen based on where the user is with respect to the device. The device also might power down if a user's head is not detected within a period of time. A device also might accept device motions as input as well, such as to display additional information in response to a moving of a user's head or tilting of the device (causing the relative location of the user to change with respect to the device). These input mechanisms can thus depend upon information from various cameras (or sensors) to determine things like motions, gestures, and head movement.

In one example, the relative direction of a user's head can be determined using one or more images captured using a single camera. In order to get the relative location in three dimensions, it can be necessary to determine the distance to the head as well. While an estimate can be made based upon feature spacing viewed from a single camera, for example, it can be desirable in many situations to obtain more accurate distance information. One way to determine the distance to various features or points is to use stereoscopic imaging, or three-dimensional imaging, although various other distance or depth determining processes can be used as well within the scope of the various embodiments. For any pair of cameras that have at least a partially overlapping field of view, three-dimensional imaging can be performed by capturing image information for one or more objects from two different perspectives or points of view, and combining the information to produce a stereoscopic or “3D” image. In at least some embodiments, the fields of view can initially be matched through careful placement and calibration, such as by imaging using a known calibration standard and adjusting an optical axis of one or more cameras to have those axes be substantially parallel. The cameras thus can be matched cameras, whereby the fields of view and major axes are aligned, and where the resolution and various other parameters have similar values for each of the cameras. Three-dimensional or stereoscopic image information can be captured using two or more cameras to provide three-dimensional point data, or disparity information, which can be used to generate a depth map or otherwise determine the distance from the cameras to various features or objects. For a given camera pair, a stereoscopic image of at least one object can be generated using the respective image that was captured by each camera in the pair. Distances measurements for the at least one object then can be determined using each stereoscopic image.

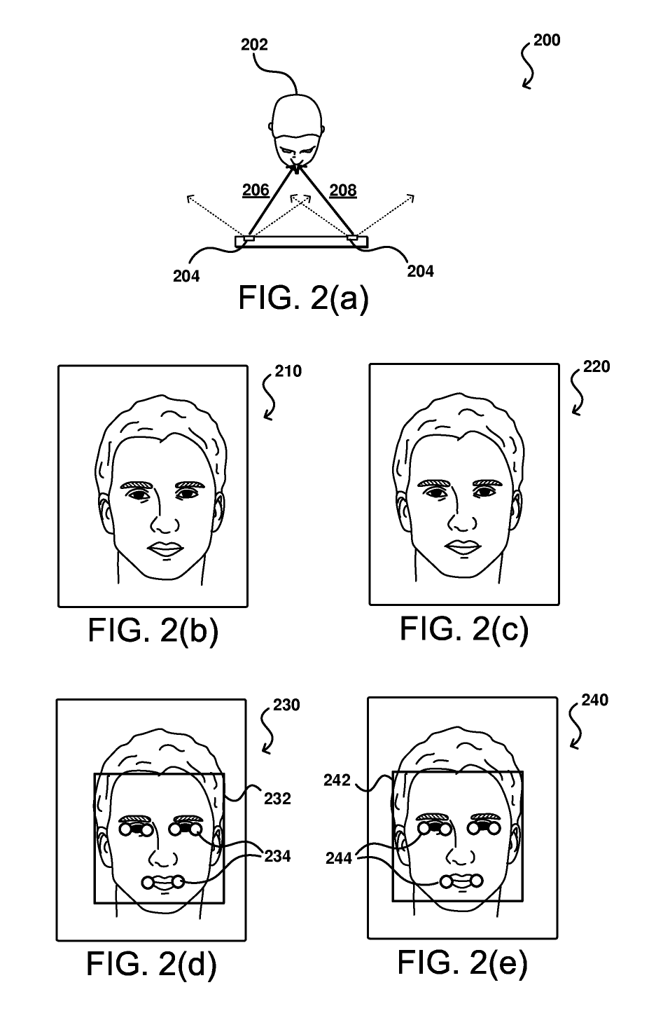

FIGS. 2(a) through 2(e) illustrate an example approach for determining the relative position of a user's head to a computing device. In the situation 200 illustrated in FIG. 2(a), a computing device includes a pair of stereo cameras 204 that are capable of capturing stereo image data including a representation of a head 202 of a user (or other person within a field of view of the cameras). Because the cameras are offset with respect to each other, objects up to a given distance will appear to be at different locations in images captured by each camera. For example, the direction 206 to a point on the user's face from a first camera is different from the direction 208 to that same point from the second camera, which will result in a representation of the face being at different locations in images captured by the different cameras. For example, in the image 210 illustrated in FIG. 2(b) the features of the user appear to be slightly to the right in the image with respect to the representations of corresponding features of the user in the image 220 illustrated in FIG. 2(c). The closer the features are to the cameras, the greater the offset between the representations of those features between the two images. For example, the nose, which is closest to the camera, may have the largest amount of offset, or disparity. The amount of disparity can be used to determine the distance from the cameras as discussed elsewhere herein. Using such an approach to determine the distance to various portions or features of the user's face enables a depth map to be generated which can determine, for each pixel in the image corresponding to the representation of the head, the distance to portion of the head represented by that pixel.

Various approaches to identifying a head or face of a user can be utilized in different embodiments. For example, images can be analyzed to locate elliptical shapes that may correspond to a user's head, or image matching can be used to attempt to recognize the face of a particular user by comparing captured image data against one or more existing images of that user. Another approach attempts to identify specific features of a person's head or face, and then use the locations of these features to determine a relative position of the user's head. For example, an example algorithm can analyze the images captured by the left camera and the right camera to attempt to locate specific features 234, 244 of a user's face, as illustrated in the example images 230, 240 of FIGS. 2(d) and 2(e). It should be understood that the number and selection of specific features displayed is for example purposes only, and there can be additional or fewer features that may include some, all, or none of the features illustrated, in various embodiments. The relative location of the features, with respect to each other, in one image should match the relative location of the corresponding features in the other image to within an acceptable amount of deviation. These and/or other features can be used to determine one or more points or regions for head location and tracking purposes, such as a bounding box 232, 242 around the user's face or a point between the user's eyes in each image, which can be designated as the head location, among other such options. The disparity between the bounding boxes and/or designated head location in each image can thus represent the distance to the head as well, such that a location for the head can be determined in three dimensions.

In many embodiments, a face detection and/or tracking process utilizes an object detector, also referred to as a classifier or object detection template, to detect all possible instances of a face under various conditions. These conditions can include, for example, variations in lighting, user pose, time of day, type of illumination, and the like. A face detector searches for specific features in an image in an attempt to determine the location and scale of one or more faces in an image captured by a camera (or other such sensor) of a computing device. In some embodiments, the incoming image is scanned and each potential sub-window is evaluated by the face detector. Face detector templates will often be trained using machine learning techniques, such as by providing positive and negative training examples. These can include images that include a face and images that do not include a face. Different classifiers can be trained to detect different types or categories of objects, such as faces, bikes, or birds, for example.

The training process in various embodiments requires a very large number of positive (and negative) examples that can cover different variations that are expected to be seen in various inputs. In conventional face tracking applications, for example, there is no a priori knowledge about the type of the face (male vs. female, ethnicity), lighting conditions (indoor vs. outdoor, shadow vs. sunny), or pose of the user, that will likely be present in a particular image. In order to successfully detect faces under a wide range of conditions, the training data generally will contain examples of faces under different view angles, poses, lighting conditions, facial hair, glasses, etc. Increasing the variability in the training data allows the face detector to find faces under these varying conditions. By using a larger range of training data to cover a wide variety of cases, however, the average accuracy level can be decreased, as there can be higher rates of potential false detections. Using a specific set of training data can improve accuracy for a certain class of object or face, for example, but may be less accurate for other classes.

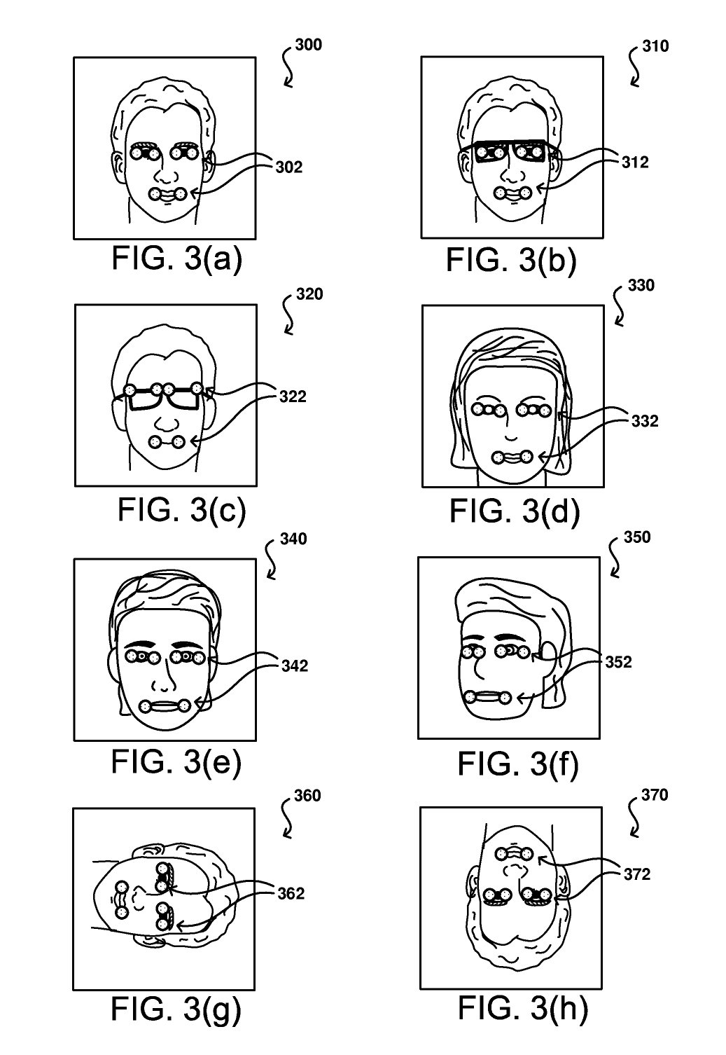

As examples, FIGS. 3(a) through 3(h) illustrate images that might be received to a face detector in various embodiments. It should be understood that “face detectors” are used as a primary example herein, but that other detectors such as head detectors, body detectors, object detectors, and the like can be used as well within the scope of the various embodiments. FIG. 3(a) illustrates an example image 300 including a representation of the user from FIG. 1(a). As mentioned, the face detector can attempt to locate specific features 302 of a face, compare the relative positions of those features to ranges known to the detector to correspond to a face, and then upon determining that the features and relative positions correspond to a face, can return one or more positions (such as a center of a bounding box or center position between the user's eyes) as a current location of the face in the image. Other processes can then take this location information and other location information to determine a relative position of the user, track that position over time, or perform another such process.

As mentioned, however, the features detectable in an image, and the relative arrangement and/or spacing of those features, can vary significantly between images due to various factors. For example, in the example image 310 of FIG. 3(b) the user is wearing glasses that may obscure a portion of the user's face that would otherwise be used to determine the appropriate location of the features 312 in that image. Various other objects might obscure such features as well. The features 312 determined thus might not accurately correspond to the intended features, or might correspond to features of the glasses or objects, among other such options. In some cases, the features may not be able to be identified at all. Accordingly, the presence and arrangement of the features might cause a face detector to be unable to identify the face in the image.

Similarly, the lighting conditions might affect the presence and/or arrangement of features identifiable in a captured image. For example, in the example image 320 of FIG. 3(c) a low light condition has caused an IR illumination source to be activated on the computing device. The way in which IR reflects from an object, such as a face or glasses, can be very different from the way in which ambient light reflects from an object. For example, the way that the glasses and mouth appear in the image 320 are very different from the way they appeared in the image 310 captured using ambient light, which thus can cause the location of the detected features 322 to be quite different. In this case, the lenses of the glasses reflect light such that the user's eyes are unable to be seen in the image, and thus unable to be detected. In order to recognize appropriate features 322 in the image, a different detector or template may be required.

Aspects of different users can result in substantially different feature locations as well. For example, the features 332 identified for a woman in the example image 330 of FIG. 3(d) have a substantially different relative arrangement or spacing than that of the man illustrated in FIG. 3(a). Similarly, a man of a different ethnicity or geographic region illustrated in the example image 340 of FIG. 3(e) may have a significantly different relative positioning of certain features 342. It is possible to make the ranges of feature distances and arrangements large enough to cover all these situations, but larger ranges can lead to higher rates of false positives as discussed previously.

Even for a single known user there can be different situations that can lead to different apparent feature arrangements. For example, in the image 350 of FIG. 3(f) a perspective view of the user is represented in the image instead of a substantially normal view. This perspective view can be the result of the user turning the head, moving the device, or causing a camera at the side of the device to capture the image, among other such options. As illustrated, different arrangements of the features 352 exist as well, as features on one side will appear closer together than features on the other side due to the perspective. FIGS. 3(g) and 3(h) illustrate different views as well, such as where the user is holding the device in such a way that the representation of the user is at a ninety degree angle (with respect to a normal “upright” representation) or upside down, respectively. The features 362, 372 thus will have arrangements that are similar to those for an upright representation, but the model or template would need to be run at these particular angles with respect to the images in order to identify the face and determine the appropriate features. Running the classifier (or instances of the classifier) at multiple angles can significantly increase the amount of resources needed for such a process. Further, running a face detector on an “upside down” image can result in a number of false positives, such as where the user has a beard or other features that might cause a face detector to return incorrect information about the face location, such as where the beard near the top of the image is interpreted as hair and the hair near the bottom is interpreted as a beard.

Accordingly, approaches in accordance with various embodiments can utilize multiple face detector templates for face detection and tracking, and can attempt to determine information such as the state of the device, the user (or type of user), or an environmental condition in order to dynamically select the appropriate template to use for face detection. As mentioned, terms such as “up” and “down” are used for purposes of explanation and are not intended to imply specific directional requirements unless otherwise specifically stated herein.

In some embodiments, an offline analysis can be performed to determine situations where the typical selections, locations, relative positions, and/or arrangement of features are such that different templates may be beneficial. This can include, for example, a template for ambient light images and a template for infrared (IR) light images. Similarly, for a device with two or more cameras that are separated an appreciable distance on the device, a template for a normal or straight-on view might be used, as well as one or more templates for different poses or views, such as may be captured by a side camera or a camera at an angle with respect to a user. Similarly, templates for low light conditions with high exposure or gain settings might warrant a dedicated template. For each of these situations, a state of the device (e.g., orientation or active IR source) or environmental condition (e.g., amount of ambient light) can be determined that dictates which template to use for face tracking at a current point in time.

Such an analysis can also be performed to determine when different templates might be advantageous for different types of users. For example, it might be beneficial to use a different template for men than for women, and for adults versus children. It might also be beneficial to utilize different templates for different regions or ethnicities, as facial dimensions and relative feature arrangements may differ significantly between different regions, such as a region of Asia with respect to a region of Europe or Africa. It also might be beneficial to have different templates for users who wear glasses or have certain types of facial hair. Any or all of these and other aspects of a user might be beneficial to use to determine the optimal template for face detection and tracking.

For each of these aspects, however, the computing device in at least some embodiments has to determine the appropriate aspect to use in selecting a template. Various approaches for determining these aspects can be used in accordance with the various embodiments. For example, a facial recognition process might be run to attempt to identify a user for which specific information, such as age, gender, and ethnicity, are known to the device or application. A particular user might login using username, password, biometric, or other such information that can be used to identify a specific user as well. For some users for which specific information is not known, one or more processes can be used to attempt to determine one or more aspects of the user. This can include, for example, capturing and analyzing one or more images to attempt to determine recognizable aspects of a user, such as age range or gender. In some embodiments, information such as the location of the device can be used to select an appropriate template. For example, a device located in Asia might start with an Asian data-trained template, while a device located in South America might start with a different template trained using different but more relevant data. The location can be determined using GPS data, IP address information, or any other appropriate information determinable by, or available to, a computing device or application executing on that device, such as may utilize a GPS, signal triangulation process, or other such location determination component or process. If there are multiple users of a device, information such as the way in which the user is holding or using the device might be indicative of a particular user for which to select a template. If a face cannot be detected using a specific template, additional attempts can be made by rotating the template (or image data) or using a different template, among other such options. In some embodiments the dynamic determination of the appropriate template to use can include a ranking of templates based on available information. For example, the use of IR light to capture an image instead of ambient light might cause a greater difference than differences between genders, such that an IR template might be ranked higher than a gender-specific template, unless a template exists that is trained on both. In some embodiments, the various classes can have different rankings or weightings such that templates can be selected for use in a specific order unless available information dictates otherwise. In some embodiments categories might be created that include templates for specific combinations of features, such as a female child illuminated by IR or a male adult illuminated by ambient light, among other such options. A template determination algorithm can analyze the available information and determine and/or infer the appropriate category. In some embodiments a generic template might be used when no information is available that indicates the appropriate template to use. In other embodiments a device might track which template(s) are most used on that device and start with those template(s) if no other information is available. Various other approaches can be used as well within the scope of the various embodiments. In some embodiments different templates can developed starting with the same face detector and using different data sets, while other embodiments might start with different detectors developed for different features, types of objects, etc.

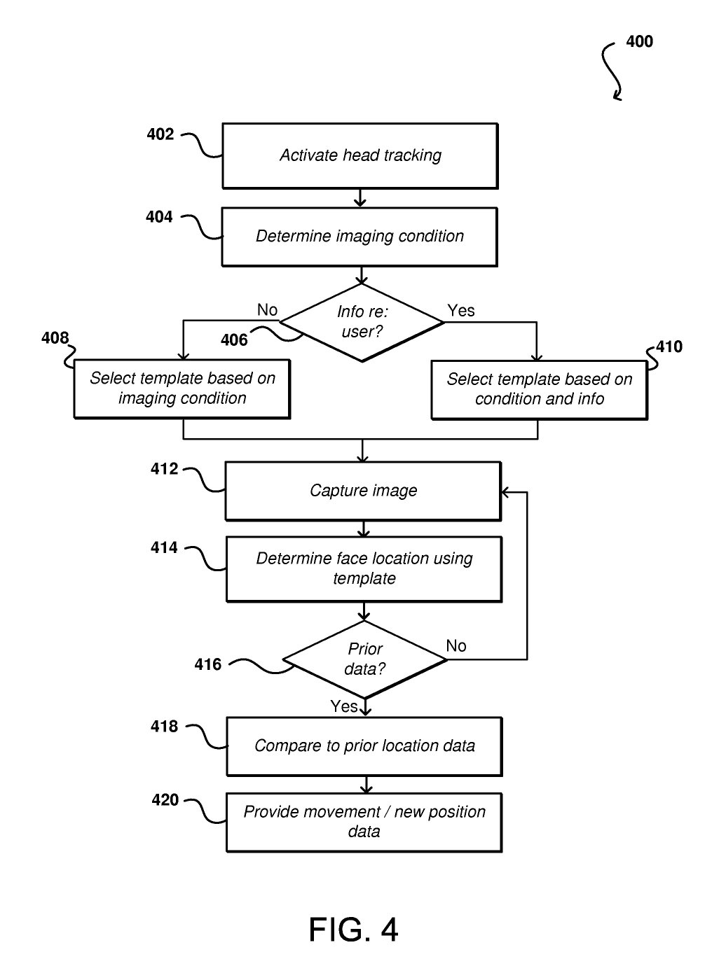

FIG. 4 illustrates an example process 400 for selecting a template to use for face tracking that can be utilized in accordance with various embodiments. It should be understood that there can be additional, fewer, or alternative steps performed in similar or alternative orders, or in parallel, within the scope of the various embodiments unless otherwise stated. Further, although discussed with respect to face tracking it should be understood that various other types of objects can be located and/or tracked using such processes as well. In this example, head tracking is activated 402 on a computing device. In various embodiments head tracking might be activated automatically or manually by a user, or started in response to an instruction from an application or operating system, among other such options. An “imaging condition” can be determined 404 which can affect which template is appropriate for the current situation. As discussed herein, an imaging condition can include a state of a computing device (e.g., whether IR illumination is active, whether the gain exceeds a certain level, or whether the device is in a particular orientation) or an environmental condition (e.g., an amount of ambient light, a time of day, or a geographic location). A determination can also, or alternatively, be made 406 as to whether any information is available about the user that can help to determine the appropriate template. As mentioned, the user information can include information about age, identity, gender, ethnicity, skin tone, use of glasses or presence of facial hair, or other such information. If information is available about the user, a template can be selected 408 based at least in part upon the imaging condition and user information. As mentioned, in some embodiments the templates might be ranked based on the available information, and at least the top ranked or scored template used to attempt to locate a face in a captured image. If information is not available about the user, the imaging condition data can be used to select the appropriate template 410. In some embodiments, the default template selection can be based upon whether IR light is active on the device and/or the orientation of the device, each of which should be determinable for most devices under any circumstances where the device is operating normally.

Once a template has been selected (or before or during the selection process in some embodiments) one or more images can be captured 412 or otherwise acquired using at least one camera of the computing device. As discussed, in some embodiments this can include a pair of images captured using stereoscopic data that provides distance information, in order to more accurately analyze relative feature positions for a given distance. The selected template then can be used to analyze the image and attempt to determine a face location 414 for the user. As mentioned, this can include detecting features in the image and using the selected face detector template to determine whether those features are indicative of a human face, and then determining a location of the face based at least in part upon the locations of those features. If it is determined 416 that there is no prior face position data, at least for the current session or within a threshold amount of time, then another image can be captured and analyzed using the process. If prior data exists, then the current head location data can be compared 418 to the prior location data to determine any change, or at least a change that exceeds a minimum change threshold. A minimum change threshold might be used to account for noise or slight user movements, which are not meant to be used as input and thus may not result in any change in the determined head location for input purposes. If there is a change, information about the change, movement, and/or new head position can be provided 420 as input to an application or service, for example, such as an application that tracks head position over time for purposes of controlling one or more aspects of a computing device.

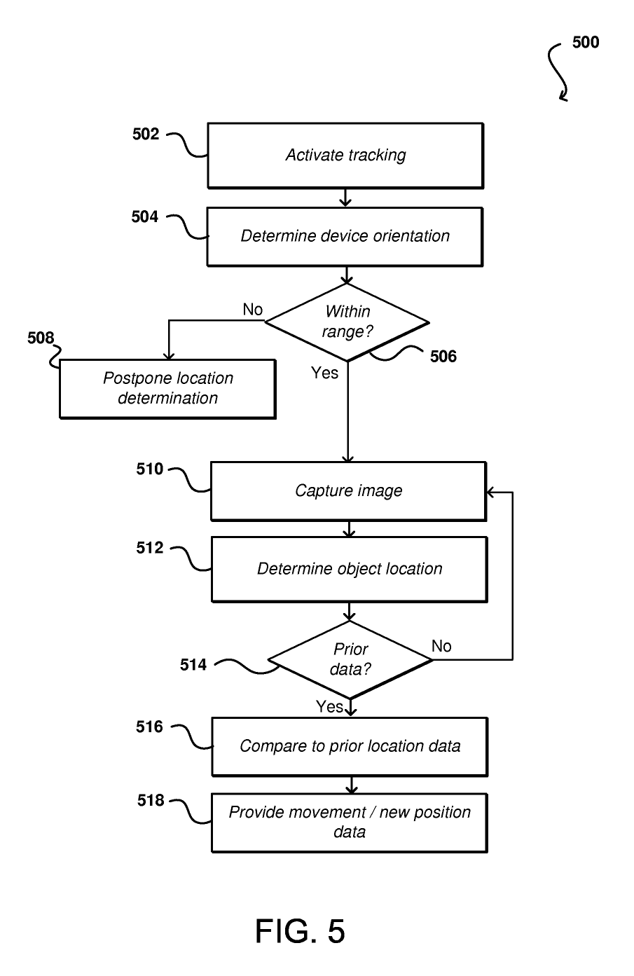

Although not shown in FIG. 5, as discussed elsewhere herein it is possible that no face will be detected using the selected template. Accordingly, another template may be selected to attempt to analyze the image and detect a face of a user. As mentioned, however, in some embodiments the same template will be used more than once, but with the template (or image data) rotated to attempt to locate a face that might not be represented in an “upright” or normal view in the image, such as where the device might be rotated by ninety or a hundred and eighty degrees, or where the user may be on his or her side while using the device. In some embodiments, the template might be used for at least four different rotations, such as for a normal orientation (with the user's eyes above the user's mouth in the image), at ninety degrees, at one-hundred eighty degrees, and at two-hundred seventy degrees, although other orientations can be utilized as well in various embodiments. The angles used can depend at least in part upon the maximum angle which a user's head can be positioned with respect to the camera while still enabling the template to recognize a face. As mentioned, while such an approach can provide for relatively accurate results, it can require significant additional processing and can introduce additional latency into a head tracking process. Further, analyzing a face using a one-hundred eighty degree rotation, or “upside down” rotated template (or upside down trained template) can potentially result in false positives or inaccurate position information, such as where a user has a beard that might be interpreted as hair in an upside down representation, with the user's hair being interpreted as a beard. Various other issues can result as well.

Accordingly, approaches in accordance with various embodiments can limit the rotation angle over which the device (or an application executing on the device) is willing to analyze using a template for face detection. For example, a template might be able to be trained to recognize a face that is rotated plus or minus sixty degrees from normal, or “upright” in the image. Thus, a single template can cover one-hundred twenty degrees of rotation. For at least some embodiments, the device might only use one orientation of a template in order to attempt to recognize a face, and be willing to not provide for face or head detection and tracking outside that device orientation range. This might be done for different device orientations, with an “up” orientation of the device being selected as the normal direction for range selection purposes. In other embodiments, the device might utilize different template rotations, such as plus or minus ninety degrees, but may ignore the “upside down” orientation of one-hundred and eighty degrees as the device may be unlikely to be in that orientation with respect to a user, and the upside down orientation may be too susceptible to inaccuracies. In still other embodiments, a device might completely suspend face tracking processes if the device is in an upside down orientation, or in an orientation that is outside a determined range of acceptable orientations (such as more than sixty degrees from a conventional orientation such as portrait or landscape).

FIG. 5 illustrates an example process 500 for selecting template orientations to use for face tracking in accordance with various embodiments. In this example, tracking is activated 502 on the computing device. As mentioned with respect to the previous process, the tracking can be activated manually or automatically, and can involve the tracking of a head, face, or other such object. An orientation of the device can be determined 504, such as by using a device sensor or orientation sensor, such as an electronic gyroscope or electronic compass, among other such sensors. A determination can be made 506 as to whether the device is within an acceptable range of orientations for tracking. For example, this can include the device being in a portrait or landscape orientation, with the major or minor axis of the face of the device being substantially vertical, for example, or within a determined range of vertical, such as plus or minus thirty degrees, plus or minus sixty degrees, or plus or minus ninety degrees. In some embodiments the device can be in range unless the device is determined to be in a substantially upside down orientation. In other embodiments, the range can refer to the orientation of the object with respect to the device, as a template might be run to analyze features in an image over a specified range, but templates may not be run to detect features over other ranges, such as for objects that might be represented upside-down in a captured image. If the device is outside the allowable range for tracking, the location determination process can be suspended or postponed 508 at least until the device is back within the acceptable range of orientations.

If the device is within range, one or more images can be captured 510 or otherwise acquired using at least one camera of the computing device. As discussed, in some embodiments this can include a pair of images captured using stereoscopic data that provides distance information, in order to more accurately analyze relative feature positions for a given distance. A template, which may be selected in some embodiments using one of the processed discussed herein in some embodiments, can be used to analyze the image and attempt to determine an object location 512 with respect to the device. As mentioned, this can include detecting features in the image and using a selected detector template to determine whether those features are indicative of a specified object, such as a human face, and then determining a location of the object based at least in part upon the locations of those features. If it is determined 514 that there is no prior position data, at least for the current session or within a threshold amount of time, then another image can be captured and analyzed using the process. If prior data exists, then the current location data can be compared 516 to the prior location data to determine any change, or at least a change that exceeds a minimum change threshold as discussed above. If there is a change, information about the change, movement, and/or new position can be provided 518 as input to an application or service, for example, such as an application that tracks head position over time for purposes of controlling one or more aspects of a computing device.

A specific example is provided that incorporates both the processes of FIGS. 4 and 5. In this example, a portable computing device is considered that has at least four cameras, one near each corner of the front face of the device. Accordingly, a different pair will be near the “top” of the device when the device is in a portrait orientation than when in a landscape orientation. Further, the device has a light sensor and circuitry that, upon determining that the amount of ambient light around the device is less than a minimum threshold amount, such as an amount necessary to adequately illuminate a face, can automatically activate an IR source, such as an IR LED for each corner camera, on the front of the device, to illuminate at least a portion of a field of view of one or more active cameras. The four corner cameras can detect reflected light over both the visible (with a wavelength between 390 and 700 nm) and IR (with wavelengths between 700 nm to 1 mm) spectrums in this example, although some sensors may be optimized for specific sub-spectrums in some embodiments. In such a device, a device sensor such as a compass or gyroscope can be used to determine device orientation. In at least some embodiments, device orientation can determine which of the cameras is/are active, such as the cameras near the top in the current orientation, while in other embodiments other factors such as obstructions and preferences can be used to determine the active cameras. Further, the device will be able to determine whether IR illumination is active. Based on the orientation, IR illumination state, and active cameras, a template can be selected that is appropriate for face detection. As mentioned, if the device orientation is outside a specified range of orientations, face detection may be suspended at least until the device is back in the specified orientation range. Further, the size of the device can determine whether different templates are necessary for different orientations, as devices with small separations between cameras will generally have a forward-facing representation, but devices with large camera separations or with cameras far from center might capture objects from a side or perspective view, which might be better processed with a different template.

As mentioned, the appearance of the face can be dramatically different when illuminated by ambient light sources (e.g., the sun or fluorescent lamps) than when illuminated with IR LEDs. Following traditional face detection training approaches, a single monolithic face detector could be trained by adding IR-illuminated face examples to the ambient illuminated face examples in the training data to generate a combined template. Similar approaches could be used with the orientation and camera angle differences. However, approaches discussed herein can train different face detectors, each trained using a respective type of training data, allowing each individual face detector to be more accurate (and fast) within their respective categories. Further, since the information used to select between these templates can be readily determined, the template selection can be dynamically performed with relatively high accuracy. In such embodiments, the device can use what is within the control of the device to select the best template to use under a particular situation for a particular device state.

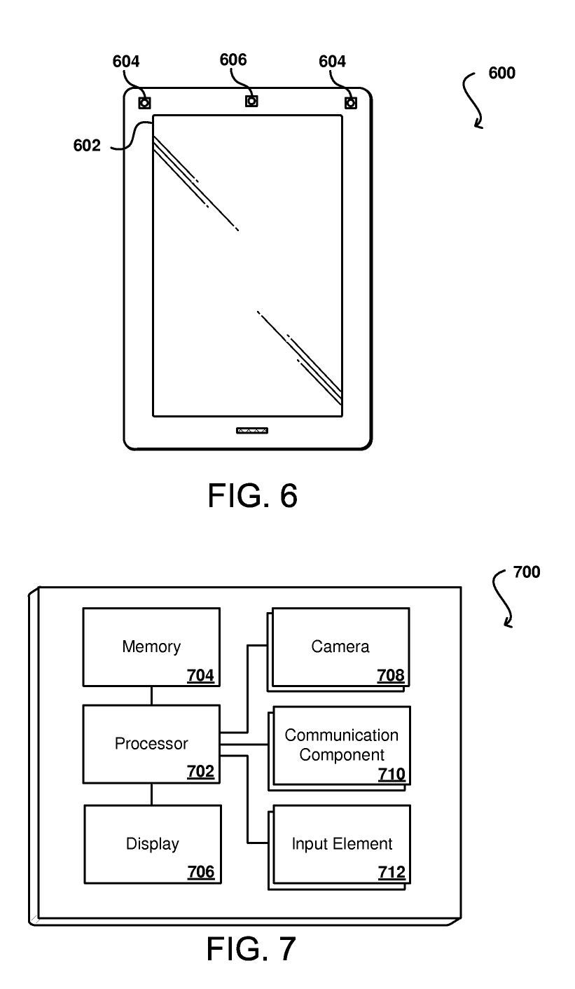

FIG. 6 illustrates an example electronic user device 600 that can be used in accordance with various embodiments. Although a portable computing device (e.g., an electronic book reader or tablet computer) is shown, it should be understood that any electronic device capable of receiving, determining, and/or processing input can be used in accordance with various embodiments discussed herein, where the devices can include, for example, desktop computers, notebook computers, personal data assistants, smart phones, video gaming consoles, television set top boxes, and portable media players. In this example, the computing device 600 has a display screen 602 on the front side, which under normal operation will display information to a user facing the display screen (e.g., on the same side of the computing device as the display screen). The computing device in this example includes at least one pair of stereo cameras 604 for use in capturing images and determining depth or disparity information, such as may be useful in generating a depth map for an object. The device also includes a separate high-resolution, full color camera 606 or other imaging element for capturing still or video image information over at least a field of view of the at least one camera, which in at least some embodiments also corresponds at least in part to the field of view of the stereo cameras 604, such that the depth map can correspond to objects identified in images captured by the front-facing camera 606. In some embodiments, the computing device might only contain one imaging element, and in other embodiments the computing device might contain several imaging elements. Each image capture element may be, for example, a camera, a charge-coupled device (CCD), a motion detection sensor, or an infrared sensor, among many other possibilities. If there are multiple image capture elements on the computing device, the image capture elements may be of different types. In some embodiments, at least one imaging element can include at least one wide-angle optical element, such as a fish-eye lens, that enables the camera to capture images over a wide range of angles, such as 180 degrees or more. Further, each image capture element can comprise a digital still camera, configured to capture subsequent frames in rapid succession, or a video camera able to capture streaming video.

The example computing device can include at least one microphone or other audio capture device capable of capturing audio data, such as words or commands spoken by a user of the device, music playing near the device, etc. In this example, a microphone is placed on the same side of the device as the display screen, such that the microphone will typically be better able to capture words spoken by a user of the device. In at least some embodiments, a microphone can be a directional microphone that captures sound information from substantially directly in front of the microphone, and picks up only a limited amount of sound from other directions. It should be understood that a microphone might be located on any appropriate surface of any region, face, or edge of the device in different embodiments, and that multiple microphones can be used for audio recording and filtering purposes, etc.

FIG. 7 illustrates a logical arrangement of a set of general components of an example computing device 700 such as the device 600 described with respect to FIG. 6. In this example, the device includes a processor 702 for executing instructions that can be stored in a memory device or element 704. As would be apparent to one of ordinary skill in the art, the device can include many types of memory, data storage, or non-transitory computer-readable storage media, such as a first data storage for program instructions for execution by the processor 702, a separate storage for images or data, a removable memory for sharing information with other devices, etc. The device typically will include some type of display element 706, such as a touch screen or liquid crystal display (LCD), although devices such as portable media players might convey information via other means, such as through audio speakers. As discussed, the device in many embodiments will include at least camera 708 or infrared sensor that is able to image projected images or other objects in the vicinity of the device, or an audio capture element able to capture sound near the device. As mentioned, a camera in various embodiments can include multiple sensors sensitive to one or more spectrums of light, such as the infrared and visible spectrums. Methods for capturing images or video using a camera element with a computing device are well known in the art and will not be discussed herein in detail. It should be understood that image capture can be performed using a single image, multiple images, periodic imaging, continuous image capturing, image streaming, etc. Further, a device can include the ability to start and/or stop image capture, such as when receiving a command from a user, application, or other device. The example device can include at least one mono or stereo microphone or microphone array, operable to capture audio information from at least one primary direction. A microphone can be a uni-or omni-directional microphone as known for such devices.

In some embodiments, the computing device 700 of FIG. 7 can include one or more communication components 710, such as a Wi-Fi, Bluetooth, RF, wired, or wireless communication system. The device in many embodiments can communicate with a network, such as the Internet, and may be able to communicate with other such devices. In some embodiments the device can include at least one additional input element 712 able to receive conventional input from a user. This conventional input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual and audio commands, such that a user can control the device without having to be in contact with the device.

The device also can include at least one orientation or motion sensor. As discussed, such a sensor can include an accelerometer or gyroscope operable to detect an orientation and/or change in orientation, or an electronic or digital compass, which can indicate a direction in which the device is determined to be facing. The mechanism(s) also (or alternatively) can include or comprise a global positioning system (GPS) or similar positioning element operable to determine relative coordinates for a position of the computing device, as well as information about relatively large movements of the device. The device can include other elements as well, such as may enable location determinations through triangulation or another such approach. These mechanisms can communicate with the processor, whereby the device can perform any of a number of actions described or suggested herein.

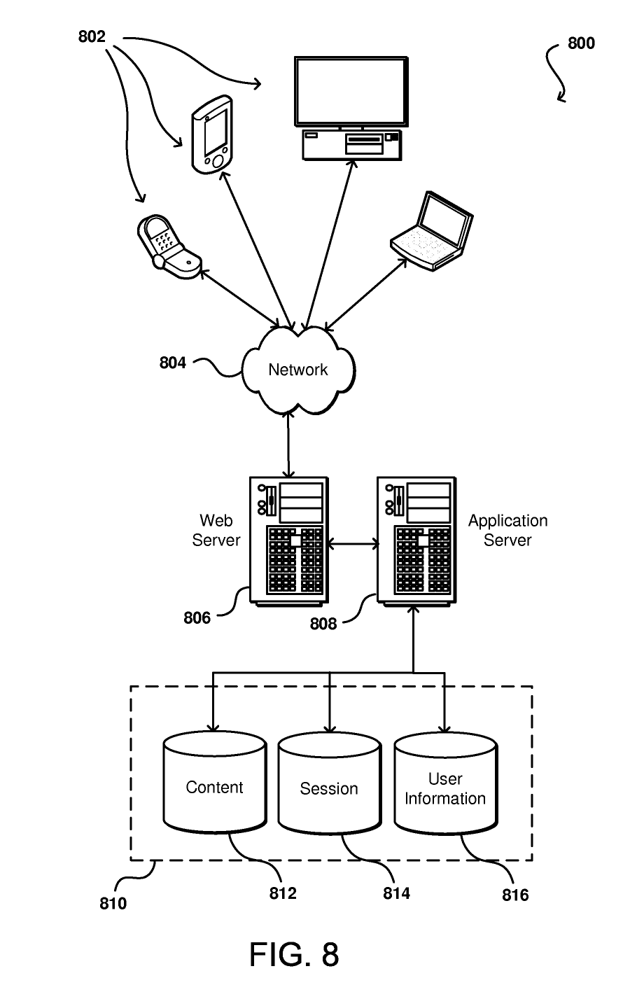

As discussed, different approaches can be implemented in various environments in accordance with the described embodiments. While many processes discussed herein will be performed on a computing device capturing an image, it should be understood that any or all processing, analyzing, and/or storing can be performed remotely by another device, system, or service as well. For example, FIG. 8 illustrates an example of an environment 800 for implementing aspects in accordance with various embodiments. As will be appreciated, although a Web-based environment is used for purposes of explanation, different environments may be used, as appropriate, to implement various embodiments. The system includes an electronic client device 802, which can include any appropriate device operable to send and receive requests, messages or information over an appropriate network 804 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server 806 for receiving requests and serving content in response thereto, although for other networks an alternative device serving a similar purpose could be used, as would be apparent to one of ordinary skill in the art.

The illustrative environment includes at least one application server 808 and a data store 810. It should be understood that there can be several application servers, layers or other elements, processes or components, which may be chained or otherwise configured, which can interact to perform tasks such as obtaining data from an appropriate data store. As used herein the term “data store” refers to any device or combination of devices capable of storing, accessing and retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server in the form of HTML, XML or another appropriate structured language in this example. The handling of all requests and responses, as well as the delivery of content between the client device 802 and the application server 808, can be handled by the Web server 806. It should be understood that the Web and application servers are not required and are merely example components, as structured code discussed herein can be executed on any appropriate device or host machine as discussed elsewhere herein.

The data store 810 can include several separate data tables, databases or other data storage mechanisms and media for storing data relating to a particular aspect. For example, the data store illustrated includes mechanisms for storing production data 812 and user information 816, which can be used to serve content for the production side. The data store also is shown to include a mechanism for storing log or session data 814. It should be understood that there can be many other aspects that may need to be stored in the data store, such as page image information and access rights information, which can be stored in any of the above listed mechanisms as appropriate or in additional mechanisms in the data store 810. The data store 810 is operable, through logic associated therewith, to receive instructions from the application server 808 and obtain, update or otherwise process data in response thereto. In one example, a user might submit a search request for a certain type of element. In this case, the data store might access the user information to verify the identity of the user and can access the catalog detail information to obtain information about elements of that type. The information can then be returned to the user, such as in a results listing on a Web page that the user is able to view via a browser on the user device 802. Information for a particular element of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 8. Thus, the depiction of the system 800 in FIG. 8 should be taken as being illustrative in nature and not limiting to the scope of the disclosure.

As discussed above, the various embodiments can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Various aspects also can be implemented as part of at least one service or Web service, such as may be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, FTP, UPnP, NFS, and CIFS. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and non-transitory computer-readable media for containing code, or portions of code, can include any appropriate media known or used in the art, such as but not limited to volatile and non-volatile, removable and non-removable media implemented in any method or technology for storage of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A computing device, comprising:
at least one processor;
a camera configured to capture light in a visible spectrum and light in an infrared (IR) spectrum;
a light sensor configured to determine an amount of ambient light in an environment of the computing device;
an IR illumination source configured to provide IR illumination when the camera is active and the amount of ambient light, as detected by the light sensor, is below a light threshold; and
a memory device including instructions that, when executed by the at least one processor, cause the computing device to:
acquire an image using the camera;
determine a state of the IR illumination source at a time of capture of the image;
select a face detection template based at least in part upon the state of the IR illumination source, the face detection template selected from a plurality of face detection templates including at least a first face detection template trained for images captured using light in the visible spectrum and a second face detection template for images captured using light in the IR spectrum;
analyze the image using the face detection template to identify a plurality of features in the image that are indicative of a representation of a face in the image; and
determine position information indicating the location of the representation of the face in the image as determined using the plurality of features.

2. The computing device of claim 1, further comprising:
an orientation sensor configured to determine an orientation of the device at the time of capture of the image, wherein the camera is selected from a plurality of cameras of the computing device, wherein the face detection template is further selected based at least in part upon the determined orientation of the device and which of the plurality of cameras is selected to acquire the image, the face detection template being further selected based at least in part upon the relative position of the camera selected from the plurality of cameras to acquire the image.

3. The computing device of claim 1, wherein the instructions when executed further cause the computing device to:
activate the IR illumination source in response to the amount of ambient light in the environment of the computing device falling below the light threshold; and
switch to the second face detection template for images captured using light in the IR spectrum.

4. The computing device of claim 1, further comprising:
a location determination component configured to determine a geographic location of the computing device at the time of capture of the image, wherein the face detection template is further selected based at least in part upon the determined geographic location to specify a face detection template trained using images captured of users associated with the geographic location.

5. A computer-implemented method, comprising:
acquiring an image using a camera of a computing device;
determining a state of the computing device associated with a time of acquiring of the image, the state determinable using at least one sensor of the computing device;
selecting an object detection template based at least in part upon the state;
analyzing the image using the object detection template to detect a representation of an object in the image; and
determining information about a location of the representation of the object in the image.

6. The computer-implemented method of claim 5, wherein analyzing the image using the object template further comprises:
locating a plurality of features in the image;
comparing relative positions of at least a subset of the features to the object template; and
determining a likely identity of the object represented in the image.

7. The computer-implemented method of claim 5, wherein the object detection template is one of a plurality of object detection templates, each template of the plurality of object detection templates being trained using a respective set of images captured for a specific state of the computing device.

8. The computer-implemented method of claim 5, wherein determining the state of the computing device further comprises:
determining at least one of a state of an IR illumination source of the computing device, an exposure setting of the camera, a gain setting of the camera, an orientation of the computing device, a value of a light sensor, or a state of each of a plurality of cameras on the computing device.

9. The computer-implemented method of claim 5, further comprising:
determining at least one aspect of a user at least partially represented in the image, wherein the object detection template is selected based at least in part upon a combination of the determined at least one aspect of the user with the state of the computing device.

10. The computer-implemented method of claim 9, wherein determining the at least one aspect further comprises:
determining at least one of a gender of the user, an approximate age of the user, an ethnicity of the user, a skin tone of the user, or an object worn by the user.

11. The computer-implemented method of claim 9, wherein determining the at least one aspect further comprises:
identifying the user, or a type of the user, based at least in part upon at least one of identifying information provided by the user or identifying information detected using at least one device sensor of the computing device.

12. The computer-implemented method of claim 9, further comprising:
ranking two or more object detection templates based at least in part upon the determined state of the computing device and the at least one aspect of the user; and
selecting, based at least in part upon the ranking, at least one object detection template for use in analyzing the image, wherein an additional object detection template is selected in response to the object being unable to be identified in the image using the selected object detection template.

13. The computer-implemented method of claim 5, wherein analyzing the image further comprises analyzing the image using the object detection template in more than a first orientation.

14. The computer-implemented method of claim 5, further comprising:
acquiring an additional image using the camera;
determining an orientation of the computing device at a time of acquiring of the additional image;
determining that the orientation falls outside an allowable orientation range for object detection; and
preventing the additional image from being analyzed using the object detection template.

15. The computer-implemented method of claim 5, further comprising:
analyzing a subsequently-captured image using a general object detection template when at least one of a state of the device or at least one aspect of a user is unable to be determined, the general object detection template trained using multiple types of training data.

16. The computer-implemented method of claim 5, wherein the object detection template is a face detection template selected from a plurality of different face detection templates, each face detection template of the plurality of different face detection templates trained using data for a different group of users having a respective set of representative features.

17. A computer-implemented method, comprising:
acquiring an image using a camera of a computing device;
determining, using an orientation sensor, an orientation of the computing device at a time of acquiring of the image;
determining that the orientation of the computing device falls within an allowable orientation range for object detection; and
analyzing the image to detect an object represented in the image.

18. The computer-implemented method of claim 17, further comprising:
acquiring an additional image using the camera;
determining, using the orientation sensor, a second orientation of the computing device at a time of acquiring of the additional image;
determining that the second orientation of the computing device falls outside the allowable orientation range for object detection; and
preventing the additional image from being analyzed for the second orientation.

19. The computer-implemented method of claim 18, wherein the allowable orientation range is a range of one hundred twenty degrees about a primary device orientation.

20. The computer-implemented method of claim 17, further comprising:
analyzing the image using at least one instance of an object detection template to detect the object represented in the image, wherein the at least one instance is used at one or more orientations within a range of allowable analysis orientations.

21. The computer-implemented method of claim 17, further comprising:
preventing an instance of the at least one instance from being used to analyze the image in an orientation opposite an original orientation of the image.
